(19) United States
(12) Patent Application Publication
(10) Pub. No.: US 2011/0031826 A1
(43) Pub. Date: Feb. 10, 2011

(54) PERMANENT MAGNET MACHINE AND ROTOR

(75) Inventors: James William Bray, Niskayuna, NY (US); Manoj Ramprasad Shah, Niskayuna, NY (US); Jeremy Daniel VanDam, Niskayuna, NY (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, SCHENECTADY, NY (US)

(21) Appl. No.: 12/536,566

(22) Filed: Aug. 6, 2009

(51) Int. Cl. H02K 5/18; H02K 21/22

(52) U.S. Cl. 310/64; 310/156.12; 310/156.26

(57) ABSTRACT

A permanent magnet machine is disclosed. The permanent magnet machine includes a stator, and a rotor comprising a rotor core and disposed outside and concentric with the stator, wherein the rotor core comprises a contiguous volume disposed around a plurality of permanent magnets, wherein the contiguous volume simultaneously supports a magnetic flux generated by the permanent magnets and provides mechanical support and containment for the permanent magnets, during operation of the permanent magnet machine. A rotor for a permanent magnet electric machine is also disclosed.

The invention relates generally to permanent magnet (PM) machines, and more specifically to rotors of permanent magnet machines.

Many new aircraft systems are designed to accommodate electrical loads that are greater than those on current aircraft systems. The electrical system specifications of commercial airliner designs currently being developed may demand up to twice the electrical power of current commercial airliners. This increased electrical power demand must be derived from mechanical power extracted from the engines that power the aircraft. When operating an aircraft engine at relatively low power levels, e.g., while idly descending from altitude, extracting this additional electrical power from the engine mechanical power may reduce the ability to operate the engine properly.

Traditionally, electrical power is extracted from the high-pressure (HP) engine spool in a gas turbine engine. The relatively high operating speed of the UP engine spool makes it an ideal source of mechanical power to drive the electrical generators connected to the engine. However, it is desirable to draw power from additional sources within the engine, rather than rely solely on the HP engine spool to drive the electrical generators. The LP engine spool provides an alternate source of power transfer, however, the relatively lower speed of the LP engine spool typically requires the use of a gearbox, as slow-speed electrical generators are often larger than similarly rated electrical generators operating at higher speeds.

PM machines (or generators) are a possible means for extracting electric power from the LP spool. However, aviation applications have stringent size and weight requirements that are difficult to satisfy with conventional PM machine designs.

Currently available PM machines display high stator core and rotor magnet losses during operation due to their high speeds and winding structures. Attempts to design efficient stators and rotors to mitigate the above losses often result in an increase in complexity of their design, which in turn, makes PM machines incorporating such designs commercially unattractive.

A PM machine having a design that is simpler compared to currently available PM machines, but which can be produced at a higher rating, thereby allowing higher speed operation for a given rotor size, would therefore be highly desirable.

### BRIEF DESCRIPTION

Embodiments of the invention are directed to simplified designs for backirons of PM machines.

One aspect of the invention resides in a permanent magnet machine, comprising a stator, and a rotor. The rotor comprises a rotor core and is disposed outside and concentric with the stator. The rotor core comprises a contiguous volume disposed around a plurality of permanent magnets, wherein the contiguous volume simultaneously supports a magnetic flux generated by the permanent magnets and provides mechanical support and containment for the permanent magnets, during operation of the permanent magnet machine.

Another aspect of the invention resides in a rotor for a permanent magnet machine. The rotor comprises a plurality of permanent magnets configured to produce a magnetic flux, and a magnetic backiron, wherein the magnetic backiron supports the magnetic flux, and provides all mechanical support for radial containment of the permanent magnets, during operation of the permanent magnet machine.

These and other advantages and features will be more readily understood from the following detailed description of preferred embodiments of the invention that is provided in connection with the accompanying drawings.

### DRAWINGS

FIG. 1 is a diagrammatic illustration of a section of a prior art inside-out permanent magnet machine.

FIG. 2 is a radial cross sectional view of a permanent magnet machine, in accordance with one embodiment of the invention.

FIG. 3 is a radial cross sectional view of a permanent magnet machine, in accordance with one embodiment of the invention.

FIG. 4 is a radial cross sectional view of a permanent magnet machine, in accordance with one embodiment of the invention.

FIG. 5 is a radial cross sectional view of a permanent magnet machine, in accordance with one embodiment of the invention.

FIG. 6 is a graph that shows the variation of a peak stress within a backiron as function of thickness of a backiron for a permanent magnet machine operating at a given fixed speed, in accordance with one embodiment of the invention.

### DETAILED DESCRIPTION

In the following description, whenever a particular aspect or feature of an embodiment of the invention is said to comprise or consist of at least one element of a group and combinations thereof, it is understood that the aspect or feature may comprise or consist of any of the elements of the group, either individually or in combination with any of the other elements of that group.

As discussed in detail below, embodiments of the invention are directed to improved rotor backiron designs. The designs proposed here provide for a simplified rotor backiron, which serves at least two purposes. Firstly, it provides a return path for a magnetic flux generated by a plurality of permanent magnets disposed within the rotor. Secondly, it provides structural support for the rotor against centripetal forces produced during rotation of the rotor. Embodiments of the invention are also amenable to provision of means for ventilation of the rotor.

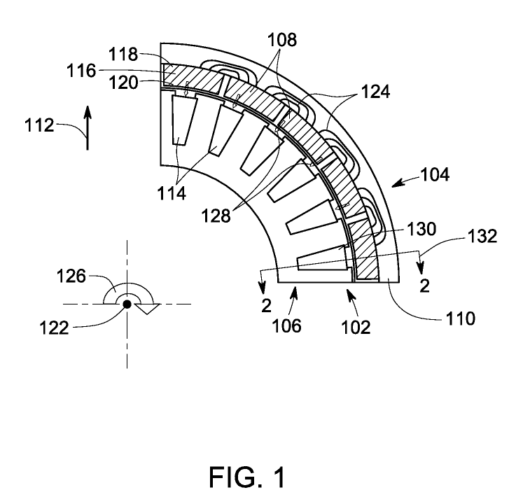

FIG. 1 is a diagrammatic illustration of a section of a prior art inside-out PM machine 102. The PM machine 102 includes a rotor 104, and a stator 106, wherein the rotor 102 is disposed “externally,” to the stator 106. The rotor 104 further includes a plurality of permanent magnets 108. For the presently depicted arrangement, the permanent magnets 108 are disposed mediate to the stator 106 and the rotor backiron 110. Various configurations for the disposition of the permanent magnets 108 within the rotor 104 are known in the art. For instance, in the illustrated arrangement, the permanent magnets 108 are disposed along a radial direction 112 of the rotor 104. Furthermore, operation and design principles of a PM machine that would be known to one of skill in the art, dictate that the permanent magnets be disposed according to specific prescriptions. For illustration, permanent magnet 116 is disposed so that its north pole 118 is disposed radially distally while its south pole 120 is disposed radially proximally with respect to a geometric center 122 (not depicted) of the PM machine. The stator 106 includes a plurality of stator slots 114, the design and purpose of which would be known to one of skill in the art. FIG. 1 further illustrates a portion of the magnetic flux 124 generated by the permanent magnets 108. It is evident that the rotor backiron 110 supports the magnetic flux 124 as it flows between any two or more of the permanent magnets 108.

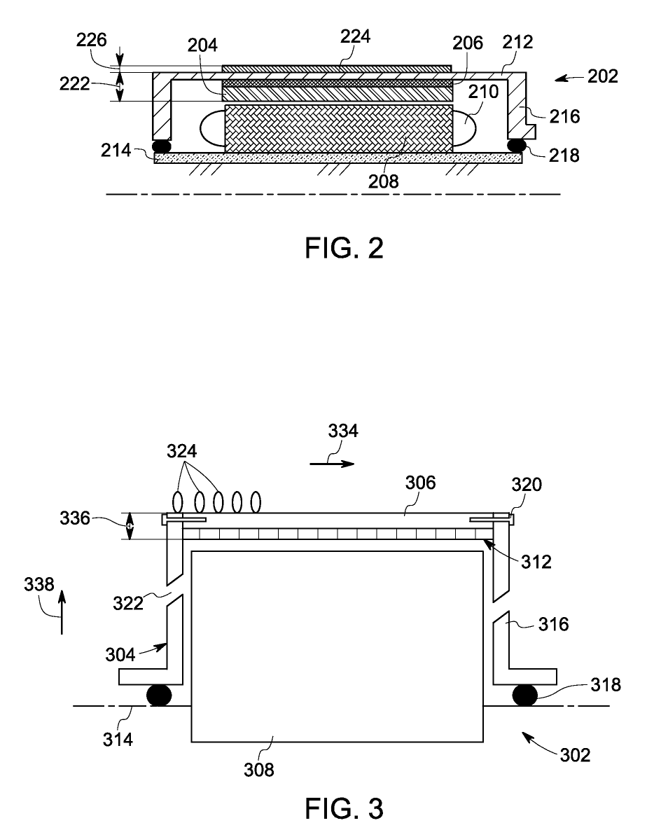

During operation of the PM machine 102, the rotor 104 displays a rotational velocity 126, for instance, in the manner shown (FIG. 2). According to well known mechanical principles, during operation, a centripetal force 128 pointing radially inwards would be generated, for instance, in the manner shown. It will be evident to one of skill in the art that, under action of the centripetal force 128, the permanent magnets 108 would load against the rotor backiron 110. In addition therefore, to performing its function of supporting the magnetic flux 124, the rotor backiron 110 needs to be mechanically stable during operation of the PM machine 102 against loading from the permanent magnets 108.

Quite generally therefore, in addition to other factors, rotor design considerations must address the above electromagnetic and mechanical function requirements, viz., respectively, the requirement that a rotor (for instance, of type 104) support a magnetic flux (for instance, of type 124), and that the rotor be mechanically stable during operation of the PM machine (for instance, of type 102) of which it (that is, the rotor) is a part, against loading from a plurality of permanent magnets (for instance, of type 108).

Typical prior art design approaches to enable the rotor 104 to perform its electromagnetic and mechanical functions as discussed above are discussed in relation to FIG. 2. FIG. 2 shows, in radial cross sectional view along, for instance, at least a cross section 132 (FIG. 1) of the PM machine 102 (FIG. 1). In the interest of clarity, FIG. 1 shows less detail, than is shown in FIG. 2. For instance, portion 202 is a more detailed radial cross sectional view of the rotor 104 (FIG. 1) along the cross section 132. Reference numeral 204 indicates a radial cross sectional view along cross section 132 of the permanent magnet 116 (FIG. 1). Reference numeral 206 indicates a radial cross sectional view along cross section 132 of the rotor backiron 110 (FIG. 1). Reference numeral 208 indicates a radial cross sectional view along cross section 132 of an “underlying” positioned stator slot 130 (FIG. 1). In FIG. 2, the electromagnetic coil passing through stator slot 130 is depicted via reference numeral 210. In addition to a more detailed depiction of portions of FIG. 1 as discussed above, FIG. 2 further depicts, in radial cross sectional view along cross section 132, a shaft 212 which is mechanically coupled to the rotor backiron 110, and rotatably rests upon a supporting frame 214 via one or more bearing discs 216 and ball bearings 218, which supporting frame 214, bearing discs 216, and ball bearings 218, are again shown in radial cross section view.

The prior art design approach to enable the rotor 104 to perform its electromagnetic and mechanical functions typically provides for independent structures, wherein each structure is designed to perform one or the other function. Materials used for the fabrication of the independent structures are chosen keeping in mind the specific purpose of the particular independent structure. For instance, as shown in FIG. 2, the rotor backiron 110 (depicted as in 206) is typically composed of a ferromagnetic material, which enables it to support the magnetic flux 124 generated by the permanent magnets 108. A radial thickness 222 of the rotor backiron 110, depicted in radial cross sectional view along cross section 132, is typically chosen to be substantially the minimum necessary to support the magnetic flux 124. A separate structure, “retaining ring,” is provided to perform the mechanical function as discussed above. For instance, a retaining ring 224 composed of a high strength material, depicted in radial cross sectional view along cross section 132, is provided to support the backiron 110 during the loading that it (that is, the backiron 110) experiences during operation of the PM machine 102. A radial thickness 226 of the backiron 110, depicted in radial cross sectional view along cross section 132, is typically chosen to be the substantially the minimum necessary to mechanically support the backiron 110 when loaded during operation of the PM machine 102. The reasons for minimizing the radial thickness 222 of the backiron 110 and the radial thickness 226 of the retaining ring 224 are known to one of skill in the art and concern, among other factors, the operational and material costs of operating and manufacturing a PM machine.

It will be appreciated by one of skill in the art that the multiple requirements referred to herein require distinct design and manufacture considerations. For instance, during operation of a PM machine, the present rotor backiron needs to be able to support magnetic flux, while the present rotor shaft and retaining ring need to be able to support loading and rotational stresses. Furthermore, PM machine design and operation considerations require that the shaft (for instance of type 212), the backiron (for instance, of type 110), and the retaining ring (for instance, of type 224), be mechanically coupled intimately, so that their movements, are synchronized with each other. In other words, PM machine design and operation considerations require that the shaft, the backiron, and the retaining ring, maintain the same relative orientation during operation of the PM machine. In order to do so, various coupling schemes are used, to intimately mechanically couple the shaft, the backiron, and the retaining ring. As will be appreciated by one of skill in the art, such coupling schemes add to the cost of manufacture and maintenance of the PM machine.

Embodiments of the invention disclosed herein at least provide enhanced solution schemes for the electromagnetic and mechanical functions as discussed above, that a rotor backiron is required to perform. FIG. 3 illustrates, in radial cross-sectional view, a PM machine 302, in accordance with one embodiment of the invention.

The PM machine 302 includes a rotor 304, which rotor 304 includes a backiron 306, the “unified” design of which (discussed below) enables it to address at least both the electromagnetic and mechanical functions as discussed above. The PM machine 302 includes a stator 308 around which are disposed a plurality of permanent magnets 312. For ease of illustration, only one “segmented” permanent magnet 312 is depicted in FIG. 3. In particular embodiments, each of the permanent magnets 312 includes a plurality of segments arranged along an axial direction 334. Even though the permanent magnet 312 shown in FIG. 3 is a “segmented” permanent magnet, the use of unsegmented permanent magnets may also be compatible with embodiments of the present invention.

The “integrated” backiron (I-backiron), an embodiment 306 of which is depicted in FIG. 3, combines at least the multiple functions of a shaft (for instance, of a type that is depicted via element 212), a backiron (for instance, of a type that is depicted via element 206), and a retaining ring (for instance, of type 224), and constitutes one of the aspects of the present invention. For instance, the I-backiron 306 supports a magnetic flux 332 generated by the permanent magnets 312. It will be appreciated by one of skill in the art that the multiple (electromagnetic and mechanical) functions referred to herein require distinct design and manufacture considerations. Prior art approaches to meet these considerations have therefore been limited to providing separate physical members to separately address the multiple separate functions. An insight, which substantially enabled aspects of the I-backiron invention resulted from the realization by the inventors, that the requirement for intimate mechanical coupling of the shaft, the backiron, and the retaining ring, can be best satisfied if they are fabricated from and as a single piece of material. The material must of course, possess suitable electromagnetic and mechanical properties in order for the resulting 1-backiron to perform the electromagnetic and mechanical functions, discussed above, that are required of it.

For the illustrated arrangement, the 1-backiron 306 rotatably rests upon a supporting frame 314 via rotor end-bells 316 and ball bearings 318, which supporting frame 314, rotor end-bells 316, and ball bearings 318 are again shown in radial cross section view in FIG. 3. The I-backiron 306 may be mechanically coupled to the rotor end-bells 316 via one or more fasteners 320.

More particular embodiments of the invention also include means to address thermal management issues related to the operation of the PM machine. For instance, the rotor end-bells 316 may include one or more ventilation orifices 322, through which a gas flow may be allowed to conduct away heat generated during operation of the PM electric machine. Quite generally, the design of the rotor end-bells 316 may be such that it defines ventilation orifices as passageways within its body. In more particular embodiments of the invention, one or more ventilation blades or fins 324 may be coupled to, or incorporated, for instance, on the 1-backiron 306, or on the rotor end-bells 316. The ventilation blades may comprise the same material as the 1-backiron 306 or they may comprise any other suitable material and incorporated suitably within embodiments of the invention.

Non-limiting examples of applications where embodiments of the rotor shown in FIG. 3 may be useful include PM machines with low eddy current heating. Non-limiting examples of PM machines with low eddy current heating include PM machines without fractional slot pitch windings.

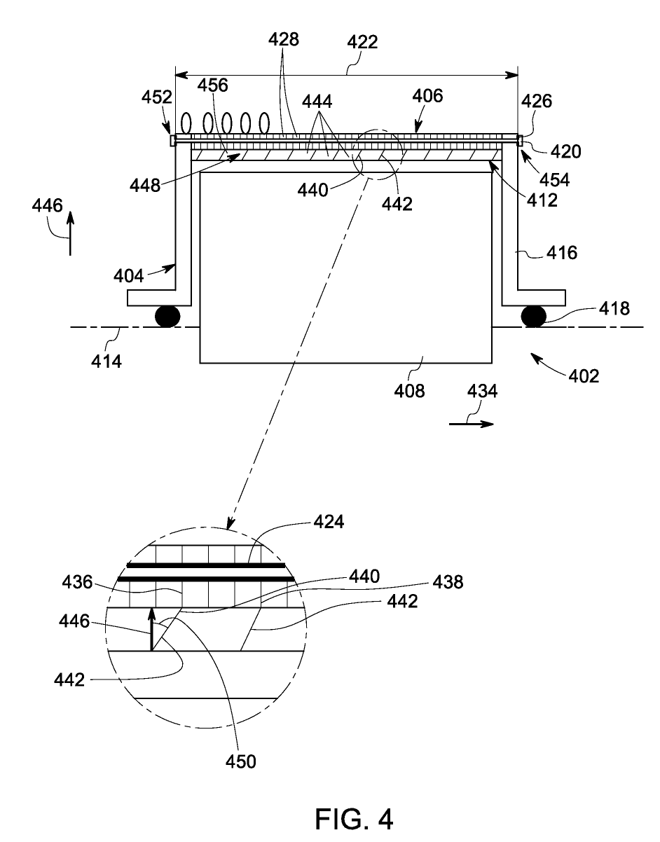

FIG. 4 depicts, in radial cross sectional view, a PM machine 402, in accordance with one embodiment of the invention. The PM machine 402 includes a rotor 404, which rotor 404 includes a backiron 406, the unified design of which (discussed below) enables it to address at least the electromagnetic and mechanical functions as discussed above. The PM machine embodiment 402 includes a stator 408 around which are disposed a plurality of permanent magnets 412. For ease of illustration, one “segmented” permanent magnet 412 is depicted in FIG. 4. For particular embodiments, the permanent magnet 412 includes a plurality of segments, which may be held together by means that are well known in the art. For instance, the segments may be glued together via suitable glues.

The I-backiron, an embodiment 406 of which is depicted in FIG. 4, combines at least the multiple functions of a shaft (for instance, of a type that is depicted via element 212), a backiron (for instance, of a type that is depicted via element 206), and a retaining ring (for instance, of type 224), and constitutes one of the aspects of the present invention. For instance, the I-backiron 406 supports a magnetic flux 432 generated by the permanent magnets 412. For the illustrated arrangement, the I-backiron 406 rotatably rests upon a supporting frame 414 via rotor end-bells 416 and ball bearings 418, which supporting frame 414, rotor end-bells 416, and ball bearings 418 are again shown in radial cross sectional view in FIG. 4. The I-backiron 406 may be mechanically coupled to the rotor end-bells 416 via one or more fasteners. Non-limiting examples of fasteners include tie-bolts (an example of which is depicted via reference numeral 420), which for instance may extend across the width 422 of the PM machine.

Quite generally therefore, embodiments of the invention include a rotor, which rotor includes, a plurality of rotor end-bells, wherein the permanent magnets are arranged between opposing ones of the rotor end-bells, and at least one bolt configured to affix the contiguous volume to the rotor end-bells. A non-limiting example of such a rotor embodiment is substantially depicted in FIG. 4, whereby the permanent magnet 412 is arranged between opposing ends (“opposing ones”) 452 and 454, and tie-bolts (for example, of type 420) affix the I-backiron 406 (“contiguous volume”) to the rotor end-bells 416. Quite generally, the I-backiron extends radially (along radial direction 446) from the tie-bolt 420.

Quite generally, embodiments of the invention include a rotor, which rotor includes electrical insulation disposed between respective ones of the at least one bolt and the rotor end bells. A non-limiting example of such a rotor embodiment is substantially depicted in FIG. 4, whereby electrical insulation 424 and 426 may be disposed respectively between the opposing ends 452 and 454 of the tie-bolt 420 and the rotor end bells 416, and between the tie-bolt 420 and the 1-backiron 406. Non-limiting examples of the electrical insulation include insulating sleeves and ceramic spacers.

Furthermore, the I-backiron 406 may comprise a plurality of laminations 428 in order to address eddy current losses issues that arise during operation of the PM machine 402. The laminations may be held together by means that are well known in the art. For instance, the laminations may be glued together via suitable glues.

It will be appreciated by one of skill in the art that, if the positioning of individual lamination interfaces, for instance, 436 and 438, of the laminations 428 coincide substantially, along the axial direction 434, with the positioning of individual segment interfaces, for instance, 440 and 442, of any permanent magnet, for instance, the permanent magnet 412, then a possibility exists that during operation of the PM machine 402, a resulting shear force may cause the segments 444 to load against the laminations 428 which in turn may lead to a displacement, along substantially a radial direction 446 of the rotor 404, of one or more of the laminations 428 and/or one or more of the segments 444. Those skilled in the art would appreciate that such a displacement would result in rotor imbalance or failure. To substantially preclude the possibility of such an occurrence, embodiments of the invention include permanent magnets, wherein a side of any individual axial segment of any individual permanent magnet makes a non-zero angle with a radial direction. A non-limiting example of such an embodiment is substantially depicted in FIG. 4, whereby a side 448 of axial segment 456 of permanent magnet 412 makes an angle 450, that is non-zero, with a radial direction 446.

Non-limiting examples of applications where embodiments of the rotor shown in FIG. 4 may be useful include PM machines that are subject to large magnetic field fluctuations in the rotor, which fluctuations are responsible at least for eddy current losses within the rotor. Non-limiting examples of PM machines subject to large magnetic field fluctuations in the rotor include PM machines with fractional slot pitch windings.

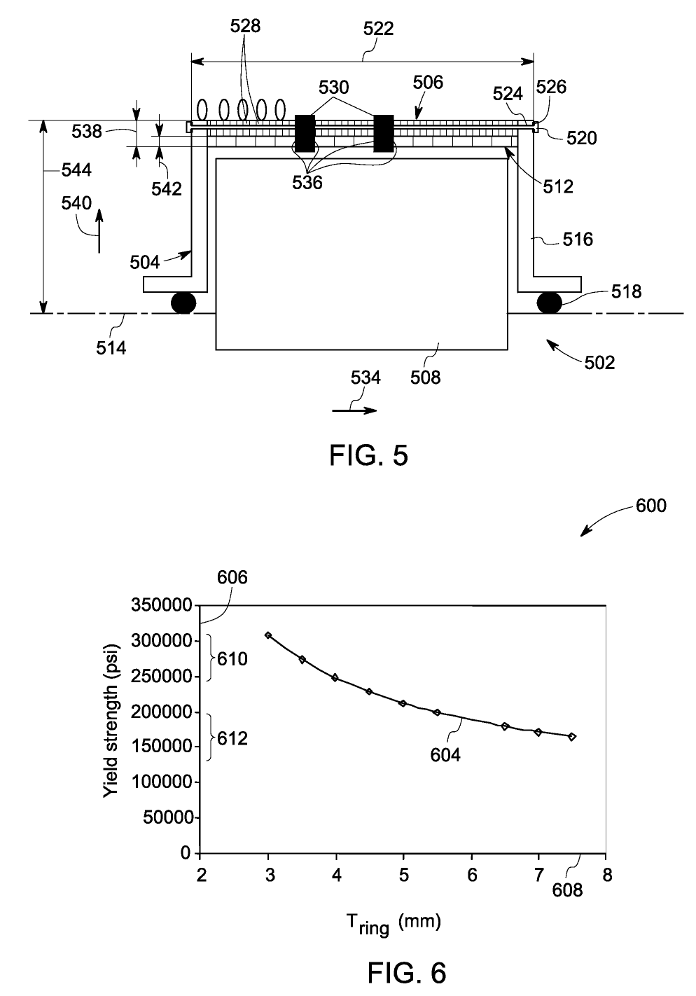

FIG. 5 depicts, in a radial cross sectional view, a PM machine 502, in accordance with one embodiment of the invention. The PM machine 502 includes a rotor 504 having an outer radius 544, which rotor 504 includes a backiron 506, the unified design of which (discussed below) enables it to address at least the electromagnetic and mechanical functions as discussed above. The PM machine embodiment 502 includes a stator 508 around which are disposed a plurality of permanent magnets 512. One “segmented” permanent magnet 512 having radial thickness 542 is depicted in FIG. 5.

The I-backiron, an embodiment 506 of which is depicted in FIG. 5, combines at least the multiple functions of a shaft (for instance, of a type that is depicted via element 212), a backiron (for instance, of a type that is depicted via element 206), and a retaining ring (for instance, of type 224), and constitutes one of the aspects of the present invention. For instance, the I-backiron 506 supports a magnetic flux 532 generated by the permanent magnets 512. The I-backiron 506 rotatably rests upon a supporting frame 514 via rotor end-bells 516 and ball bearings 518, which supporting frame 514, rotor end-bells 516, and ball bearings 518 are again shown in radial cross sectional view in FIG. 5. The I-backiron 506 may be mechanically coupled to the rotor end-bells 516 via one or more fasteners. Non-limiting examples of fasteners include tie-bolts 520 which for instance may extend across the width 522 of the PM machine. Electrical insulation 524 and 526 may be disposed respectively between the tie-bolts 520 and the rotor end bells 516, and between the tie-bolts 520 and the I-rotor 506. The I-rotor 506 may comprise a plurality of laminations 528 in order to address eddy current losses issues that arise during operation of the PM machine 502. Furthermore, intermediary support discs 530 may be provided to provide mechanical support to the axially disposed laminations 528 of the I-backiron 506.

Quite generally, embodiments of the invention include a rotor wherein the rotor includes at least one electrically isolated intermediary support disc mechanically coupled to the at least one bolt. A non-limiting example of such a rotor embodiment is substantially depicted in FIG. 5, whereby intermediary support discs 530 are disposed so that they are mechanically coupled to tie-bolt 520 and are electrically insulated from its surroundings via at least electrical insulation 536. Embodiments of intermediary support discs that extend beyond the radial dimensions of, for instance, the I-backiron, are included within the purview of the present invention. A non-limiting example of such intermediary support disc embodiment is substantially depicted in FIG. 5, whereby intermediary support discs 530 extend beyond the thickness 538 of the I-backiron 506 along the radial direction 540.

Quite generally therefore, embodiments of the invention include a permanent magnet machine (for instance, of type 302, 402, 502), including, a stator (for instance, of type 308, 408, 508), and a rotor (for instance, of type 304, 404, 504) comprising a rotor core and disposed outside and concentric with the stator, wherein the rotor core comprises a contiguous volume disposed around a plurality of permanent magnets (for instance, of type 312, 412, 512), wherein the contiguous volume simultaneously supports a magnetic flux (for instance, of type 332, 432, 532) generated by the permanent magnets and provides mechanical support and containment for the permanent magnets, during operation of the permanent magnet machine. Specific non-limiting embodiments of the permanent magnet machine include inside-out embodiments, for instance, embodiments 302, 402, and 502.

In one embodiment of the invention, the contiguous volume includes a backiron (for instance, of type 306, 406, 506). In an alternate embodiment of the invention, for instance the embodiment shown in FIG. 5, the backiron 506 (that is, the “contiguous volume”) includes a plurality of laminations (for instance, of type 528) oriented in an axial direction 534 (FIG. 5). In an alternate embodiment of the invention, for instance, the embodiment shown in FIG. 3, the backiron 306 (that is, the “contiguous volume”) completes a flux path for the magnetic flux (for instance, of type 332) generated by the permanent magnets (for instance, of type 312).

The I-backiron (for instance, of type 506) may be fabricated from any material that possesses properties required to enable it to perform the electromagnetic and mechanical functions as discussed above. A thickness 538 along a radial direction 540 of the I-backiron 506, required in order for the I-backiron 506 to perform its electromagnetic and mechanical functions is dependent upon factors that would be known to one of skill in the art. Such factors include, for instance, the material (electromagnetic and mechanical) properties of the material from which the I-backiron is fabricated, the mass of the I-backiron, the radius of the I-backiron, the speed at which the PM electric machine (of which the I-backiron is a part) is required to operate, the operational safety margin requirements of the PM electric machine, among other factors.

Non-limiting examples of the materials from which the I-backiron may be composed include high strength ferromagnetic materials such as high strength magnetic steel or cobalt alloy materials including Aermet 100, Aermet 310, Aermet 340, and AF1410. FIG. 6 is a graph 600 of computed exemplary data 604 of variation of yield strength of the I-backiron (for instance, of type 506), plotted along the ordinate 606, as a function of the radial thickness “T_{ring}” (for instance, of type 538) of the I-backiron, plotted along the abscissa 608. The data presented in FIG. 6 were computed for a rotor (for instance, of type 504) with an outer diameter (for instance, twice the outer radius of type 544) of about 300 millimeters, wherein the radial thickness (for instance, of type 542) of the permanent magnets (for instance, of type 512) was about 14 millimeters. For the purposes of the computation, the operational rating required of the rotor were at least as follows: a 120% overspeed capacity, and be operating a nominal speed of about 12000 revolutions per minute. As may be evident to one of skill in the art, a centripetal stress will develop within the I-backiron to counteract the centripetal force that acts on it as a result of such an operation. One of skill in the art will also appreciate that the ability of the I-backiron to withstand the centripetal stress is limited by the yield strength of the material from which the I-backiron is composed.

Also indicated in FIG. 6 is a representative yield strength regime of the cobalt alloy materials 610 (as discussed above), along with a representative yield strength regime of traditional nickel superalloys 612. It is evident that the yield strengths of cobalt alloys 610 are substantially greater than the yield strengths of traditional nickel superalloys 612. As may be evident to one of skill in the art, graph 600 demonstrates that I-backirons fabricated from cobalt alloy materials can deliver operational ratings that are comparable to backirons fabricated from nickel superalloys, but at reduced radial thicknesses. For instance, from graph 600 it is evident that an I-backiron fabricated from a cobalt alloy is required to have a radial thickness of about 3.5 millimeters to deliver the operational rating mentioned above. This is to be compared with the radial thickness of about 9 millimeters, that a backiron fabricated from traditional nickel superalloys must have, in order to deliver the operational rating mentioned above. In other words, other factors being substantially similar, use of cobalt alloys, would likely result in a substantial (in the present case, about 72%) reduction in the required radial thickness, and hence the material and fabrication cost of a backiron. Use of cobalt alloys to fabricate I-backirons according to embodiments of the invention are included within the purview of the present invention.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A permanent magnet machine, comprising:
a stator; and
a rotor comprising a rotor core and disposed outside and concentric with the stator, wherein the rotor core comprises a contiguous volume disposed around a plurality of permanent magnets, wherein the contiguous volume simultaneously supports a magnetic flux generated by the permanent magnets and provides mechanical support and containment for the permanent magnets, during operation of the permanent magnet machine.

2. The permanent magnet machine of claim 1, wherein the contiguous volume comprises a backiron.

3. The permanent magnet machine of claim 1, wherein the contiguous volume comprises a plurality of laminations oriented in an axial direction.

4. The permanent magnet machine of claim 1, wherein each of the permanent magnets comprises a plurality of axial segments, wherein each of the axial segments has a side, and wherein at least one of the sides makes a non-zero angle with a radial direction.

5. The permanent magnet machine of claim 1, wherein the contiguous volume completes a flux path for the magnetic flux generated by the permanent magnets.

6. The permanent magnet machine of claim 1, wherein the rotor further comprises:
a plurality of rotor end-bells, wherein the permanent magnets are arranged between opposing ones of the rotor end-bells; and
at least one bolt configured to affix the contiguous volume to the rotor end-bells.

7. The permanent magnet machine of claim 6, wherein the contiguous volume extends radially inward and outward from the at least one bolt, and wherein the rotor further comprises at least one electrically insulating member disposed between the contiguous volume and the at least one bolt.

8. The permanent magnet machine of 7, wherein the rotor further comprises electrical insulation disposed between respective ones of the at least one bolt and the rotor end bells.

9. The permanent magnet machine of claim 8, wherein the electrical insulation comprises at least one of a insulating sleeve and a ceramic spacer.

10. The permanent magnet machine of claim 6, further comprising at least one electrically isolated intermediary support disc mechanically coupled to the at least one bolt.

11. The permanent magnet machine of claim 6, wherein at least one of the rotor end-bells defines at least one ventilation orifice.

12. The permanent magnet machine of claim 1, further comprising a plurality of fins coupled to the contiguous volume.

13. A rotor for a permanent magnet machine, the rotor comprising:
a plurality of permanent magnets configured to produce a magnetic flux; and
a magnetic backiron, wherein the magnetic backiron supports the magnetic flux, and provides all mechanical support for radial containment of the permanent magnets, during operation of the permanent magnet machine.

14. The rotor of claim 13, wherein the magnetic backiron comprises a plurality of laminations oriented in an axial direction, wherein each lamination is fabricated from a high strength magnetic steel material selected from the group consisting of Aermet 100, Aermet 310, Aermet 340, AF1410, and combinations thereof.

15. The permanent magnet machine of claim 13, wherein the rotor further comprises:
a plurality of rotor end-bells, wherein the permanent magnets are arranged between opposing ones of the rotor end-bells; and
at least one bolt configured to affix the magnetic backiron to the rotor end-bells.

16. The permanent magnet machine of claim 15, wherein the magnetic backiron extends radially from the at least one bolt, and wherein the rotor further comprises at least one electrically insulating member disposed between the contiguous volume and the at least one bolt.

17. The permanent magnet machine of 15, wherein the rotor further comprises electrical insulation disposed between respective ones of the at least one bolt and the rotor end bells.

18. The permanent magnet machine of claim 17, wherein the electrical insulation comprises at least one of an insulating sleeve and a ceramic spacer.

19. The permanent magnet machine of claim 15, wherein at least one of the rotor end-bells defines at least one ventilation orifice.

20. The permanent magnet machine of claim 13, further comprising a plurality of fins coupled to the magnetic backiron.
